(19) United States
(12) Patent Application Publication
(10) Pub. No.: US 2023/0008060 A1
(43) Pub. Date: Jan. 12, 2023

(54) THROUGHPUT-BASED COMPONENT CARRIER RESOURCE ALLOCATION FOR MULTIPLE SUBSCRIPTIONS OF A USER EQUIPMENT

(71) Applicant: QUALCOMM Incorporated, San Diego, CA (US)

(72) Inventors: Sriram Parthasarathy Mannar, Hyderabad (IN); Mahender Reddy Akkapally, Hyderabad (IN); Rajeev Kumar, Bangalore (IN); Arnab Bose, Hyderabad (IN)

(21) Appl. No.: 17/368,536

(22) Filed: Jul. 6, 2021

(51) Int. Cl. H04W 72/12; H04W 72/04; H04W 8/18; H04B 7/06

(52) U.S. Cl. CPC H04W 72/1231; H04W 72/044; H04W 8/18; H04B 7/0632

(57) ABSTRACT

A method of wireless communication performed by a user equipment (UE) includes receiving one or more configuration messages indicating configuration of the UE with a first component carrier (CC) and at least a second CC for a first subscription corresponding to a first subscriber identity module (SIM) of the UE. The method further includes performing one or more operations associated with a second subscription corresponding to a second SIM of the UE during a time interval. During the time interval, communication by the first subscription using the second CC is avoided based on a first throughput associated with the first CC exceeding a second throughput associated with the second CC.

### TECHNICAL FIELD

Aspects of the present disclosure relate generally to wireless communication systems, and more particularly, to user equipment (UE) devices that use multiple subscriptions, such as in connection with a multiple subscriber identity module (MSIM) implementation of a UE.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

In some aspects of the disclosure, a method of wireless communication performed by a user equipment (UE) includes receiving one or more configuration messages indicating configuration of the UE with a first component carrier (CC) and at least a second CC for a first subscription corresponding to a first subscriber identity module (SIM) of the UE. The method further includes performing one or more operations associated with a second subscription corresponding to a second SIM of the UE during a time interval. During the time interval, communication by the first subscription using the second CC is avoided based on a first throughput associated with the first CC exceeding a second throughput associated with the second CC.

In some other aspects of the disclosure, an apparatus for wireless communication includes a transmitter and a receiver. The receiver is configured to receive one or more configuration messages indicating configuration of a first CC and at least a second CC for a first subscription corresponding to a first SIM. The receiver is further configured to perform one or more operations associated with a second subscription corresponding to a second SIM during a time interval. One or both of the transmitter or the receiver are configured to avoid, during the time interval and based on a first throughput associated with the first CC exceeding a second throughput associated with the second CC, communication associated with the first subscription using the second CC.

In some other aspects of the disclosure, a non-transitory computer-readable medium stores instructions executable by a processor of a UE to initiate, perform, or control operations. The operations include receiving one or more configuration messages indicating configuration of the UE with a first CC and at least a second CC for a first subscription corresponding to a first SIM of the UE. The operations further include performing one or more operations associated with a second subscription corresponding to a second SIM of the UE during a time interval. During the time interval, communication by the first subscription using the second CC is avoided based on a first throughput associated with the first CC exceeding a second throughput associated with the second CC.

In some other aspects of the disclosure, an apparatus for wireless communication includes means for transmitting signals. The apparatus further includes means for receiving one or more configuration messages indicating configuration of a first CC and at least a second CC for a first subscription corresponding to a first SIM. The means for receiving is configured to perform one or more operations associated with a second subscription corresponding to a second SIM of the UE during a time interval. During the time interval, communication by the first subscription using the second CC is avoided based on a first throughput associated with the first CC exceeding a second throughput associated with the second CC.

### BRIEF DESCRIPTION OF THE DRAWINGS

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system according to one or more aspects.

FIG. 4 is a flow diagram illustrating operations that may be performed by a UE according to one or more aspects.

FIG. 5 is a flow chart of a method of wireless communication performed by a UE according to some aspects of the disclosure.

FIG. 6 is a block diagram of an example UE according to one or more aspects.

### DETAILED DESCRIPTION

User equipment (UE) devices may use a subscriber identity module (SIM) to enable communication with network devices. For example, a SIM of a UE device may store information that identifies a subscription (such as a subscription to a cellular service of a cellular service provider) to enable network devices to route calls and messages to the UE device. SIMs include hardware SIMS (such as SIM cards) as well as other types of SIMs, such as embedded SIMs (eSIMs), which may be implemented using software in some devices.

Some UE devices include multiple SIMs to enable connection to multiple networks. For example, multiple SIMs may enable a UE to communicate with wireless communication networks associated with different radio access technologies (RATs). As a particular example, a UE device may include multiple SIMs to support a concurrent RAT (CRAT) scenario in which the UE device is able to concurrently communicate with network devices of different RATs.

In some circumstances, a resource conflict may occur between a subscription of one SIM of a UE device and a subscription of another SIM of the UE device. Some UE devices may use a tune-away operation to avoid or mitigate resource conflicts. In a tune-away operation, one subscription (which may be referred to a “victim”) may temporarily avoid certain types of communication (e.g., by relinquishing resources) to avoid conflict with another subscription (which may be referred to as an “aggressor”). In some cases, tune-away operations may reduce device performance, such as by reducing throughput associated with the victim subscription (e.g., by reducing an amount of bandwidth available to the victim subscription, by delaying transmission or reception of data packets, or by causing a missed or dropped call).

A technique in accordance with some aspects of the disclosure may select a component carrier (CC) having a lowest throughput for a tune-away operation. In some aspects, a UE may store to a throughput database indications of throughputs of CCs associated with a first subscription corresponding to a first SIM. In response to detecting a resource conflict between the first subscription and a second subscription corresponding to a second SIM, the UE may access the throughput database to identify the CC having the lowest throughput. To avoid or mitigate the resource conflict, the first subscription may avoid communicating using the CC while the second subscription performs one or more operations, which may increase resources available to the second subscription during the one or more operations (e.g., by “relaxing” an amount of radio frequency (RF) or baseband processing associated with the first subscription during the one or more operations). By avoiding communicating using the CC, access to one or more of RF resources or baseband resources (e.g., a processor, memory, or bus) may be increased for the second subscription, mitigating or avoiding the resource conflict.

In some implementations, the one or more operations include idle mode operations associated with the second subscription that “keep alive” a network connection associated with the second subscription. For example, the one or more operations may include one or more of monitoring for a paging message, receiving a system information block (SIB) message, or performing a network measurement.

By selecting the CC having the lowest throughput for a tune-away operation, performance in a wireless communication system may be enhanced as compared to some other techniques. For example, by selecting a “worst” performing CC based on recent channel conditions or other metrics, reduction in performance to the first subscription may be minimized or reduced as compared to techniques that select the resources randomly or according to a last-in, first-out (LIFO) or first-in, first-out (FIFO) basis. As a result, performance reduction to a victim RAT may be decreased while a total throughput associated with the UE may be increased as compared to a device that selects resources to be relinquished using another technique, such as by selecting the resources randomly or using a LIFO or FIFO technique.

Some aspects of the disclosure may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km\hat{ }2), ultra-low complexity (e.g., ˜10 s of bits/sec), ultra-low energy (e.g., ˜10+ years of battery life), and deep coverage with the capability to reach challenging locations; (2) including data security, ultra-high reliability (e.g., 99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km\hat{ }2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

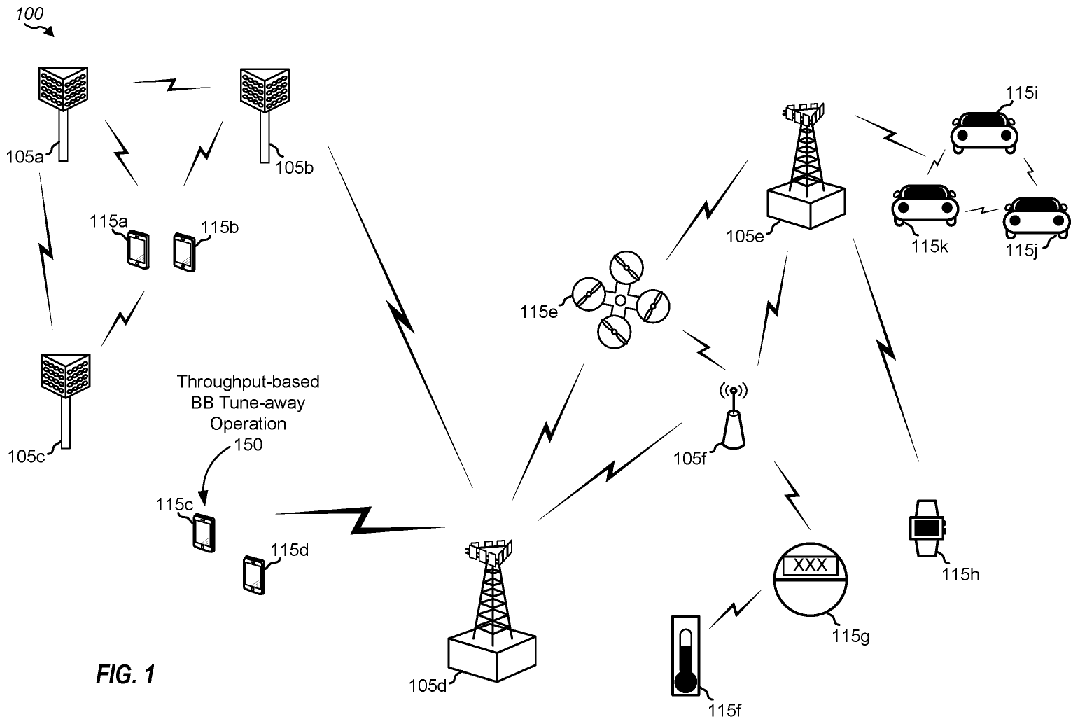

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports critical communications with ultra-reliable and redundant links for critical devices, such as UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

In some aspects of the disclosure, one or more UEs 115 are configured to perform a throughput-based CC tune-away operation. For example, in the example of FIG. 1, the UE 115c may be configured to perform a throughput-based baseband (BB) tune-away operation 150. In some examples, use of the throughput-based BB tune-away operation 150 may improve efficiency of resource allocation in a wireless communication system, as described further below.

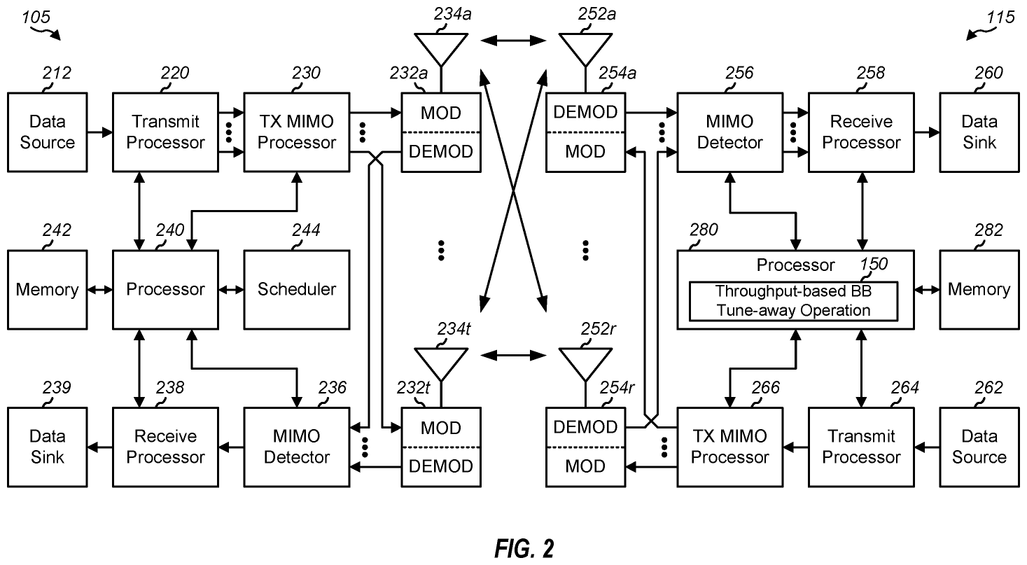

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

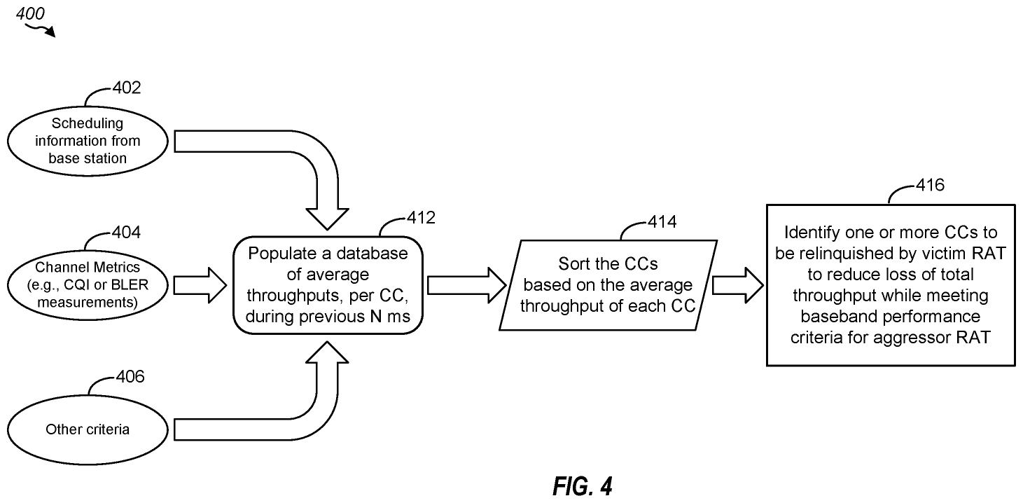

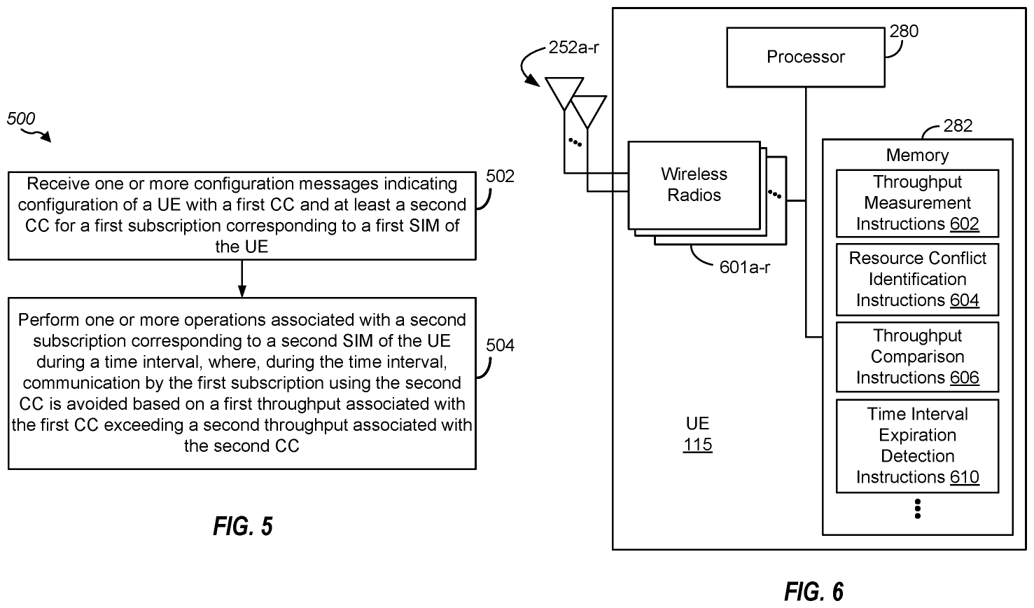

Processors 240 and 280 may direct the operation at base station 105 and UE 115, respectively. Processor 240 or other processors and modules at base station 105 or processor 280 or other processors and modules at UE 115 may perform or direct the execution of various processes for the techniques described herein. For example, the processor 280 may initiate, perform, or control one or more operations described with reference to FIG. 4, one or more operations described with reference to FIG. 5, one or more other operations described herein, or a combination thereof. As an illustrative example, the processor 280 may initiate, perform, or control the throughput-based BB tune-away operation 150. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

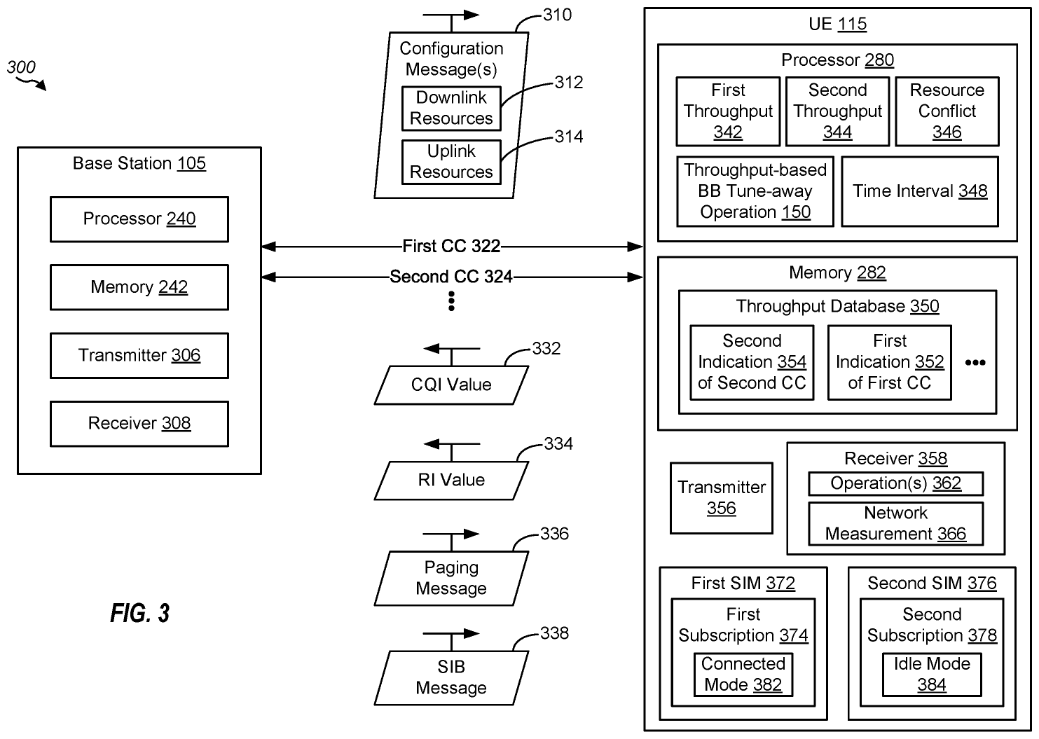

FIG. 3 is a block diagram illustrating an example of a wireless communication system 300 according to one or more aspects. The wireless communication system 300 may include one or more base stations, such as the base station 105. The wireless communication system 300 may further include one or more UEs, such as the UE 115.

The example of FIG. 3 illustrates that the base station 105 may include one or more processors (such as the processor 240) and may include the memory 242. The base station 105 may further include a transmitter 306 and a receiver 308. The processor 240 may be coupled to the memory 242, to the transmitter 306, and to the receiver 308. In some examples, the transmitter 306 and the receiver 308 include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 306 and the receiver 308 may be integrated in one or more transceivers of the base station 105.

The transmitter 306 may be configured to transmit reference signals, synchronization signals, control information, and data to one or more other devices, and the receiver 308 may be configured to receive reference signals, control information, and data from one or more other devices. For example, the transmitter 306 may be configured to transmit signaling, control information, and data to the UE 115, and the receiver 308 may be configured to receive signaling, control information, and data from the UE 115.

FIG. 3 also illustrates that the UE 115 may include one or more processors (such as the processor 280), a memory (such as the memory 282), a transmitter 356, a receiver 358, a first subscriber identity module (SIM) 372, and a second SIM 376. The processor 280 may be coupled to the memory 282, to the transmitter 356, to the receiver 358, to the first SIM 372, and to the second SIM 376. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 115.

The transmitter 356 may be configured to transmit reference signals, synchronization signals, control information, and data to one or more other devices, and the receiver 358 may be configured to receive reference signals, control information, and data from one or more other devices. For example, in some implementations, the transmitter 356 may be configured to transmit signaling, control information, and data to the base station 105, and the receiver 358 may be configured to receive signaling, control information, and data from the base station 105.

In some implementations, one or more of the transmitter 306, the receiver 308, the transmitter 356, or the receiver 358 may include an antenna array. The antenna array may include multiple antenna elements that perform wireless communications with other devices. In some implementations, the antenna array may perform wireless communications using different beams, also referred to as antenna beams. The beams may include transmit beams and receive beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. In some implementations, one or more sets of antenna elements of the antenna array may be configured to concurrently generate multiple beams, for example using multiple RF chains. A set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, the wireless communication system 300 operates in accordance with a 5G NR network. For example, the wireless communication system 300 may include multiple 5G-capable UEs 115 and multiple 5G-capable base stations 105, such as UEs and base stations configured to operate in accordance with a 5G NR network protocol such as that defined by the 3GPP.

In some implementations, the first SIM 372 is associated with a first subscription 374, and the second SIM 376 is associated with a second subscription 378. For example, the first subscription 374 may be associated with a first radio access technology (RAT) of a concurrent RAT (CRAT) environment supported by the UE 115, and the second subscription 378 may be associated with a second RAT of the CRAT environment. The second RAT may be different than the first RAT. To further illustrate, the first RAT may correspond to one of a 4G LTE wireless communication protocol or a 5G NR wireless communication protocol, and the second RAT may correspond to the other of the 4G LTE wireless communication protocol or the 5G NR wireless communication protocol. In such examples, the first SIM 372 and the second SIM 376 may support use of multiple wireless communication protocols by the UE 115, which may be deployed concurrently (e.g., in connection with the CRAT environment) in some cases. To further illustrate, the first RAT may be referred to as a “victim” RAT of the CRAT environment, and the second RAT may be referred to an “aggressor” RAT of the CRAT environment.

During operation, the UE 115 may be configured with multiple component carriers (CCs), such as a first CC 322 and a second CC 324. To illustrate, the base station 105 may transmit one or more messages, such as one or more configuration messages 310, indicating the first CC 322 and the second CC 324. In some implementations, the first CC 322 and the second CC 324 are associated with the first subscription 374.

The UE 115 may communicate using the first CC 322 and the second CC 324 in connection with the first subscription 374. For example, depending on the particular example, the UE 115 may use the first CC 322 and the second CC 324 for downlink communications, uplink communications, sidelink communications, other communications, or a combination thereof. In some examples, the UE 115 may communicate using both the first CC 322 and the second CC 324 based on a carrier aggregation (CA) technique that combines resources associated with the first CC 322 and the second CC 324 for downlink communications, uplink communications, sidelink communications, other communications, or a combination thereof.

While communicating using the first CC 322 and the second CC 324 in connection with the first subscription 374, the UE 115 may determine a first throughput 342 associated with the first CC 322 and a second throughput 344 associated with the second CC 324. For example, the UE 115 may monitor an amount of data successfully communicated using the first CC 322 during a particular time interval to determine the first throughput 342. As another example, the UE 115 may monitor an amount of data successfully communicated using the second CC 324 during a particular time interval to determine the second throughput 344. In some examples, the UE 115 measures or tracks the amount of data based on a decode statistic, such as a PDSCH decode statistic. In some such examples, the first throughput 342 may correspond to a first value of a PDSCH decode statistic indicating a first percentage of PDSCH packets received via the first CC 322 that are successfully decoded by the UE 115, and the second throughput 344 may correspond to a second value of the PDSCH decode statistic indicating a second percentage of PDSCH packets received via the second CC 324 that are successfully decoded by the UE 115.

Alternatively or in addition, the UE 115 may determine the first throughput 342 and the second throughput 344 based on one or more other parameters associated with the wireless communication system 300. For example, the UE 115 may determine the first throughput 342 and the second throughput 344 based on one or more of scheduling information received from the base station 105, a channel quality indicator (CQI) reported to the base station 105, a block error rate (BLER) measurement, or one or more other parameters, or a combination thereof. In some examples, the one or more parameters include a decode statistic associated with communications using a CC. To illustrate, the first throughput

In some implementations, the UE 115 may maintain a throughput database 350. For example, the throughput database 350 may be stored at the memory 282, and the processor 280 may initiate, perform, or control operations associated with the throughput database 350. The throughput database 350 may indicate throughputs associated with CCs (such as the first throughput 342 associated with the first CC 322 and the second throughput 344 associated with the second CC 324) or a ranking of CCs in terms of throughputs. To illustrate, after determining the first throughput 342 and the second throughput 344, the processor 280 may store, to the throughput database 350, a first indication 352 of the first CC 322 and a second indication 354 of the second CC 324.

In some examples, the processor 280 may sort the first indication 352 and the second indication 354 according to one or more metrics, such as the first throughput 342 and the second throughput 344. In an illustrative example, the processor 280 may sort the first indication 352 and the second indication 354 according to an ascending order of throughput (e.g., from “worst” throughput to “best” throughput). As an example, if the processor 280 determines that the second throughput 344 is less than the first throughput 342, the second indication 354 may occur before the first indication 352 in the throughput database 350.

In some circumstances, the UE 115 may detect a resource conflict 346 between the first subscription 374 and the second subscription 378. In some examples, the resource conflict 346 may occur based on one or more operations 362 associated with the second subscription 378. To illustrate, in some circumstances, the first subscription 374 may operate based on a connected mode 382, and the second subscription 378 may operate based on an idle mode 384. Operation based on the connected mode 382 may include transmitting signals using the transmitter 356, receiving signals using the receiver 358, or both, and operation based on the idle mode 384 may include using the receiver 358 to perform the one or more operations 362. In such examples, the resource conflict 346 may occur, such as where the first subscription 374 and the second subscription 378 are scheduled to perform operations concurrently during a particular time interval.

In some examples, the UE 115 may detect the resource conflict 346 based on scheduling information received from the base station 105, which may indicate that a communication operation of the first subscription 374 is scheduled to occur concurrently with (or within a threshold duration of) the one or more operations 362. In some examples, detecting the resource conflict 346 includes determining that communicating using both the first CC 322 and the second CC 324 (e.g., based on a CA technique) concurrently with (or within a threshold duration of) performing the one or more operations 362 may be associated with a particular baseband resource usage by the UE 115 that exceeds a baseband resource usage threshold. In some examples, the particular baseband resource usage and the baseband resource usage threshold may correspond to or may be based on a number of processing cycles of the processor 280, a number of instructions to be executed per second by the processor 280, an amount of data to be stored to the memory 282, or an amount of data to be transferred over a bus of the UE 115, as illustrative examples.

To further illustrate, the resource conflict 346 may include or correspond to a radio frequency (RF) conflict or a baseband conflict. In an example of a baseband conflict, the first subscription 374 and the second subscription 378 may concurrently access (or attempt to concurrently access) one or more baseband components of the UE 115, such as the processor 280, the memory 282, a bus of the UE 115, one or more other components, or a combination thereof. In some circumstances, a baseband conflict may result in poor performance or dropped communications, such as where accessing the processor 280 or the memory 282 by the first SIM 372 blocks the second SIM 376 from accessing the processor 280 or the memory 282 (or vice versa).

In some aspects of the disclosure, based on detecting the resource conflict 346, the UE 115 may access the throughput database 350 to identify one or more CCs to release in connection with the throughput-based BB tune-away operation 150. In some examples, the UE 115 may release the one or more CCs (also referred to herein as relinquishing, removing, or sacrificing the one or more CCs) by de-aggregating the one or more CCs from at least one other CC that are combined based on a CA technique.

To further illustrate, the processor 280 may access the throughput database 350 to identify that the first throughput 342 exceeds the second throughput 344 (e.g., based on the second indication 354 occurring prior to the first indication 352 in an ascending order of throughput). In some such examples, the processor 280 may identify the second CC 324 to be released (e.g., via the throughput-based BB tune-away operation 150) to enable the UE 115 to avoid or mitigate the resource conflict 346.

In some other examples, the UE 115 may select an indication of a CC from the throughput database 350 using one or more other techniques. For example, in some circumstances, each CC indicated by the throughput database 350 may have a common throughput. In such examples, the UE 115 may randomly or pseudo-randomly select a CC to be relinquished. In some other examples, the UE 115 may select a CC having a numerically highest or numerically lowest index value.

In some examples, the first subscription 374 avoids communicating based on the second CC 324 for at least a time interval 348, which may increase resources available to the second subscription 378 during the time interval 348 (e.g., by “relaxing” an amount of RF or baseband processing associated with the first subscription 374 during the time interval 348). For example, the resources may include RF resources (such as time and frequency resources configured by the base station 105), baseband resources (such as access to the processor 280, the memory 282, one or more other components, or a combination thereof), other resources, or a combination thereof In some examples, the first subscription 374 may optionally communicate using the first CC 322 during the time interval 348.

In some examples, the UE 115 includes a counter, and the UE 115 adjusts a value of the counter during the time interval 348. After initializing the value of the counter (e.g., to zero or to another value) at the beginning of the time interval 348, and prior to the value of the counter reaching a threshold value corresponding to the end of the time interval 348, the first subscription 374 may avoid communicating using the second CC 324. Based on detecting that the value of the counter satisfies the threshold value, the first subscription 374 may resume (or may be eligible to resume) communication using the second CC 324.

Further, during the time interval 348, the second subscription 378 may perform the one or more operations 362. The one or more operations 362 may be performed during the idle mode 384 of the second subscription 378 during the time interval 348 and while the first subscription 374 is associated with the connected mode 382.

In some examples, the UE 115 may perform a tune-away operation (such as the throughput-based BB tune-away operation 150) associated with the first subscription 374. The tune-away operation may include avoiding communication associated with the first subscription 374 using the second CC 324 for at least the time interval 348.

To illustrate, in some examples, the second CC 324 may be associated with downlink resources 312. To enable the second subscription 378 to perform the one or more operations 362, the UE 115 may transmit one or more of a CQI value 332 or a rank indicator (RI) value 334 to the base station 105 to avoid use of the downlink resources 312 by the base station 105 during the time interval 348. In some examples, the CQI value 332 and the RI value 334 indicate poor (e.g., “worst case”) channel conditions associated with the downlink resources 312, which may cause the base station 105 to avoid transmitting downlink signals using the downlink resources 312. In some other examples, the UE 115 may not indicate that the base station 105 is to avoid use of the downlink resources 312 during the time interval 348. For example, in some circumstances, the UE 115 may detect the resource conflict 346 just prior to or after initiation of a downlink transmission from the base station 105. In such cases, the downlink transmission may be associated with one or more dropped communications. In some implementations, the base station 105 may retransmit the one or more dropped communications, such as in connection with a hybrid automatic repeat request (HARQ) scheme that may include transmission of a negative acknowledgement (NACK) by the UE 115.

Alternatively or in addition to the downlink resources 312, in some examples, the second CC 324 may be associated with uplink resources 314. The UE 115 may tune the transmitter 356 to avoid use of the uplink resources 314 during the time interval 348.

In some examples, the one or more operations 362 include at least one control operation, which may be performed during the idle mode 384 of the second subscription 378. For example, the one or more operations 362 may include receiving a paging message 336 from a base station, such as the base station 105 or another base station that communicates with the UE 115 in connection with the second subscription 378. In some examples, the paging message 336 may prompt the UE 115 to perform a particular operation. For example, the paging message 336 may prompt the UE 115 to transition the second subscription 378 from the idle mode 384 to the connected mode 382 to enable the UE 115 to receive a call associated with the second subscription 378, as an illustrative example.

Alternatively or in addition, the one or more operations 362 may include receiving a system information block (SIB) message 338 from a base station, such as the base station 105 or another base station that communicates with the UE 115 in connection with the second subscription 378. The SIB message 338 may indicate control information used by the UE 115 in connection with the second subscription 378, such as search space to monitor for paging messages (such as the paging message 336), as an illustrative example.

Alternatively or in addition, the one or more operations 362 may include performing a network measurement 366. For example, the UE 115 may monitor one or more wireless communication channels associated with the second subscription 378 to determine the network measurement 366. In some examples, the UE 115 may report the network measurement 366 to the base station 105 (or another base station), such as by transmitting a measurement report indicating the network measurement 366.

After performing the one or more operations 362, the UE 115 may detect expiration of the time interval 348. In some examples, based on expiration of the time interval 348, the UE 115 may reallocate the second CC 324 to the first subscription 374 (e.g., by interrupting or terminating the throughput-based BB tune-away operation 150). In some examples, reallocating the second CC 324 to the first subscription 374 includes re-tuning the transmitter 356 to transmit based on the second CC 324. Alternatively or in addition, reallocating the second CC 324 may include tuning the receiver 358 to receive based on the second CC 324. In an illustrative example, the UE 115 may transmit one or more of an update to the CQI value 332 or an update to the RI value 334 to indicate that the second CC 324 is no longer associated with a poor channel condition (in which case the base station 105 may resume downlink communications using the second CC 324).

In some implementations, the UE 115 may periodically or occasionally perform the throughput-based BB tune-away operation 150 based on a periodicity of the one or more operations 362. To illustrate, the periodicity may correspond to one or more of a periodicity of a paging occasion to monitor for paging messages (such as the paging message 336), a periodicity of the SIB message 338, or a periodicity of the network measurement 366.

Further, in some implementations, the time interval 348 may have a duration that is based on the one or more operations 362. As an example, the time interval 348 may have a duration that corresponds to, or that is based on, one or more of a duration of a paging occasion associated with the paging message 336, a duration of a synchronization signal and physical broadcast channel (SS/PBCH) block measurement timing configuration (SMTC) window associated with the SIB message 338, or a duration associated with performing the network measurement 366. To illustrate, the UE 115 may monitor for (or may be eligible to monitor for) the paging message 336 during the paging occasion and may monitor for (or may be eligible to monitor for) the SIB message 338 during the SMTC window.

By selecting a CC having the lowest throughput for a tune-away operation, performance in a wireless communication system may be enhanced as compared to some other techniques. For example, by selecting a “worst” performing CC for relinquishing based on recent channel conditions or other metrics, reduction in performance to the first subscription 374 may be minimized or reduced as compared to techniques that select the resources randomly or according to a LIFO or FIFO basis. As a result, performance reduction to a victim RAT may be decreased while a total throughput associated with the UE 115 may be increased as compared to a device that selects resources to be relinquished using another technique, such as by selecting the resources randomly or using a LIFO or FIFO technique.

Although certain examples have been described for convenience of illustration, other examples are also within the scope of the disclosure. For example, although two CCs have been described with reference to FIG. 3, in some other examples, the UE 115 may communicate using more than two CCs and may indicate more than two CCs in the throughput database 350. In such examples, the UE 115 may determine, and may compare, throughputs associated with more than two throughputs. As another example, although two SIMS have been described with reference to FIG. 3, in some other examples, the UE more include more than two SIMs. In such examples, the throughput database 350 may indicate CCs associated with multiple SIMS of the UE 115.

To further illustrate, in some examples, the UE 115 may release more than one CC to mitigate or avoid the resource conflict 346. As an illustrative example, the resource conflict 346 may indicate an amount of resources (such as one or more of RF resources, processing bandwidth, or memory bandwidth) to be used by the second subscription 378 during the one or more operations 362. The UE 115 may select a number (or cardinality) of CCs to be released during the time interval 348 to satisfy the amount of resources to be used by the second subscription 378 during the one or more operations 362. In some instances, the number (or cardinality) of CCs may be more than one. In such examples, the UE 115 may select two or more CCs having the lowest throughput to be released during the time interval 348.

FIG. 4 is a flow diagram illustrating operations 400 that may be performed by a UE according to one or more aspects. In some examples, the operations 400 may be performed by the UE 115.

The operations 400 may include populating a database of average throughputs per CC during the previous N milliseconds (ms), at 412 (where N indicates a positive integer). The database may correspond to the throughput database 350, and the average throughputs may include the first throughput 342 and the second throughput 344. In some examples, the average throughputs are determined based on one or more of scheduling information 402 from a base station, channel metrics 404, or one or more other criteria 406.

The scheduling information 402 may include a first amount of data scheduled by the base station 105 for the first CC 322 and a second amount of data scheduled by the base station 105 for the second CC 324. In some examples, the channel metrics 404 include CQI values associated with the first CC 322 and the second CC 324, BLER measurements associated with the first CC 322 and the second CC 324, RI values associated with the first CC 322 and the second CC 324, a modulation and coding scheme (MCS) associated with one or more of the first CC 322 and the second CC 324, one or more other parameters, or a combination thereof. The one or more other criteria 406 may include a power control setting (such as a transmit power level of the transmitter 356 or a receiver power level of the receiver 358), as an illustrative example. For example, if the base station 105 is relatively far from the UE 115, the UE 115 may use a relatively high power control setting. In some cases, communication over a relatively long distance may be associated with one or more dropped communications (and loss of throughput), in which case a relatively high power control setting (such as a “max” transmit power level of the transmitter 356 or a “max” receiver power level of the receiver 358) associated with a CC may indicate that the CC is less reliable.

The operations 400 may further include sorting the CCs based on the average throughput of each CC, at 414. For example, sorting the CCs may include sorting first indication 352 and the second indication 354, such as by ordering the second indication 354 before the first indication 352 to indicate that the second throughput 344 is less than the first throughput 342, as an illustrative example.

The operations 400 may further include identifying one or more CCs to be relinquished by a victim RAT to reduce loss of total throughput while meeting baseband performance criteria for an aggressor RAT, at 416. For example, the UE 115 may identify, based on the throughput database 350, that relinquishing the second CC 324 instead of the first CC 322 may reduce the loss of total throughput while meeting baseband performance criteria for the second subscription 378.

FIG. 5 is a flow chart of a method 500 of wireless communication performed by a UE according to some aspects of the disclosure. In some examples, the method 500 is performed by the UE 115.

The method 500 includes receiving one or more configuration messages indicating configuration of the UE with a first CC and at least a second CC for a first subscription corresponding to a first SIM of the UE, at 502. For example, the UE 115 may receive the one or more configuration messages 310 indicating the first CC 322 and the second CC 324 for the first subscription 374 corresponding to the first SIM 372. In some examples, the receiver 358 may be configured to receive the one or more configuration messages 310.

The method 500 further includes performing one or more operations associated with a second subscription corresponding to a second SIM of the UE during a time interval, at 504. During the time interval, communication by the first subscription using the second CC is avoided based on a first throughput associated with the first CC exceeding a second throughput associated with the second CC. To illustrate, the UE 115 may perform the one or more operations 362 associated with the second subscription 378 during the time interval 348 based on the first throughput 342 associated with the first CC 322 exceeding the second throughput 344 associated with the second CC 324. During the time interval 348, the first subscription 374 may avoid communicating using the second CC 324. In some examples, the first subscription 374 may optionally communicate using the first CC 322 during the time interval 348. In some examples, the receiver 358 is configured to perform the one or more operations 362, such as by receiving the paging message 336, by receiving the SIB message 338, by performing the network measurement 366, or a combination thereof.

FIG. 6 is a block diagram illustrating an example of a UE 115 according to some aspects of the disclosure. The UE 115 may include structure, hardware, or components illustrated in FIG. 2. For example, the UE 115 may include the processor 280, which may execute instructions stored in the memory 282. Using the processor 280, the UE 115 may transmit and receive signals via wireless radios 601a-r and antennas 252a-r. The wireless radios 601a-r may include one or more components or devices described herein, such as the modulator/demodulators 254a-r, the MIMO detector 256, the receive processor 258, the transmit processor 264, the TX MIMO processor 266, the transmitter 356, the receiver 358, one or more other components or devices, or a combination thereof.

The memory 282 may store instructions executable by the processor 280 to initiate, perform, or control one or more operations described herein. For example, the memory 282 may store throughput measurement instructions 602 executable by the processor 280 to determine the first throughput 342 and the second throughput 344. As another example, the memory 282 may store resource conflict identification instructions 604 executable by the processor 280 to identify the resource conflict 346. As an additional example, the memory 282 may store throughput comparison instructions 606 executable by the processor 280 to compare the first throughput 342 and the second throughput 344 to determine whether the first throughput 342 exceeds the second throughput 344. As a further example, the memory 282 may store time interval expiration detection instructions 610 executable by the processor 280 to detect expiration of the time interval 348.

According to some further aspects, in a first aspect, a method of wireless communication performed by a user equipment (UE) includes receiving one or more configuration messages indicating configuration of the UE with a first component carrier (CC) and at least a second CC for a first subscription corresponding to a first subscriber identity module (SIM) of the UE. The method further includes performing one or more operations associated with a second subscription corresponding to a second SIM of the UE during a time interval. During the time interval, communication by the first subscription using the second CC is avoided based on a first throughput associated with the first CC exceeding a second throughput associated with the second CC.

In a second aspect alternatively or in addition to the first aspect, the method includes determining one or both of the first throughput or the second throughput based on one or more of scheduling information received from a base station, a channel quality indicator (CQI) reported to the base station, or a block error rate (BLER) measurement.

In a third aspect alternatively or in addition to one or more of the first through second aspects, the method includes: storing, to a throughput database stored at a memory of the UE, a first indication of the first CC; storing, to the throughput database, a second indication of the second CC; sorting the first indication and the second indication within the throughput database according to the first throughput and the second throughput; and accessing the throughput database to identify that the first throughput exceeds the second throughput.

In a fourth aspect alternatively or in addition to one or more of the first through third aspects, the method includes performing a baseband tune-away operation associated with the first subscription that includes avoiding communication associated with the first subscription using the second CC for at least the time interval.

In a fifth aspect alternatively or in addition to one or more of the first through fourth aspects, the second CC is associated with downlink resources, and the method includes transmitting one or more of a particular channel quality indicator (CQI) value or a rank indicator (RI) value to a base station to avoid use of the downlink resources by the base station during the time interval.

In a sixth aspect alternatively or in addition to one or more of the first through fifth aspects, the second CC is associated with uplink resources, and the method includes tuning a transmitter of the UE to avoid use of the uplink resources during the time interval.

In a seventh aspect alternatively or in addition to one or more of the first through sixth aspects, the one or more operations include at least one control operation performed during an idle mode of the second subscription during the time interval and while the first subscription is associated with a connected mode.

In an eighth aspect alternatively or in addition to one or more of the first through seventh aspects, the one or more operations include one or more of receiving a paging message from a base station, receiving a system information block (SIB) message from the base station, or performing a network measurement.

In a ninth aspect alternatively or in addition to one or more of the first through eighth aspects, a duration of the time interval is based on one or more of a duration of a paging occasion associated with the paging message, a duration of a synchronization signal and physical broadcast channel (SS/PBCH) block measurement timing configuration (SMTC) window associated with the SIB message, or a duration associated with performing the network measurement.

In a tenth aspect alternatively or in addition to one or more of the first through ninth aspects, the first subscription is associated with a first radio access technology (RAT) of a concurrent RAT (CRAT) environment supported by the UE, the second subscription is associated with a second RAT of the CRAT environment, the second RAT is different than the first RAT, the first RAT corresponds to a victim RAT of the CRAT environment, and the second RAT corresponds to an aggressor RAT of the CRAT environment.

In an eleventh aspect alternatively or in addition to one or more of the first through tenth aspects, the method includes, based on expiration of the time interval, reallocating the second CC to the first subscription.

In a twelfth aspect alternatively or in addition to one or more of the first through eleventh aspects, an apparatus for wireless communication includes a transmitter and a receiver. The receiver is configured to receive one or more configuration messages indicating configuration of a first component carrier (CC) and at least a second CC for a first subscription corresponding to a first subscriber identity module (SIM). The receiver is further configured to perform one or more operations associated with a second subscription corresponding to a second SIM during a time interval. One or both of the transmitter or the receiver are configured to avoid, during the time interval and based on a first throughput associated with the first CC exceeding a second throughput associated with the second CC, communication associated with the first subscription using the second CC.

In a thirteenth aspect alternatively or in addition to one or more of the first through twelfth aspects, one or both of the first throughput or the second throughput are based on one or more of scheduling information received from a base station, a channel quality indicator (CQI) reported to the base station, or a block error rate (BLER) measurement.

In a fourteenth aspect alternatively or in addition to one or more of the first through thirteenth aspects, the apparatus includes a memory configured to store a throughput database and a processor coupled to the memory. The processor is configured to: store, to the throughput database, a first indication of the first CC; store, to the throughput database, a second indication of the second CC; sort the first indication and the second indication within the throughput database according to the first throughput and the second throughput; and access the throughput database to identify that the first throughput exceeds the second throughput.

In a fifteenth aspect alternatively or in addition to one or more of the first through fourteenth aspects, communicating using the second CC is avoided in connection with a baseband tune-away operation from the second CC and associated with the first subscription.

In a sixteenth aspect alternatively or in addition to one or more of the first through fifteenth aspects, the second CC is associated with downlink resources, and the transmitter is configured to transmit one or more of a particular channel quality indicator (CQI) value or a rank indicator (RI) value to a base station to avoid use of the downlink resources by the base station during the time interval.

In a seventeenth aspect alternatively or in addition to one or more of the first through sixteenth aspects, the second CC is associated with uplink resources, and the transmitter is configured to avoid use of the uplink resources during the time interval.

In an eighteenth aspect alternatively or in addition to one or more of the first through seventeenth aspects, the receiver is further configured to perform at least one control operation of the one or more operations during an idle mode of the second subscription during the time interval and while the first subscription is associated with a connected mode.

In a nineteenth aspect alternatively or in addition to one or more of the first through eighteenth aspects, the receiver is further configured to perform the one or more operations by a paging message from a base station, by receiving a system information block (SIB) message from the base station, or by performing a network measurement.

In a twentieth aspect alternatively or in addition to one or more of the first through nineteenth aspects, the first subscription is associated with a first radio access technology (RAT) of a concurrent RAT (CRAT) environment, the second subscription is associated with a second RAT of the CRAT environment, and the second RAT is different than the first RAT.

In a twenty-first aspect alternatively or in addition to one or more of the first through twentieth aspects, the first RAT corresponds to a victim RAT of the CRAT environment, and the second RAT corresponds to an aggressor RAT of the CRAT environment.

In a twenty-second aspect alternatively or in addition to one or more of the first through twenty-first aspects, the second CC is reallocated to the first subscription based on expiration of the time interval.

In a twenty-third aspect alternatively or in addition to one or more of the first through twenty-second aspects, a non-transitory computer-readable medium stores instructions executable by a processor of a user equipment (UE) to initiate, perform, or control operations. The operations include receiving one or more configuration messages indicating configuration of the UE with a first component carrier (CC) and at least a second CC for a first subscription corresponding to a first subscriber identity module (SIM) of the UE. The operations further include performing one or more operations associated with a second subscription corresponding to a second SIM of the UE during a time interval. During the time interval, communication by the first subscription using the second CC is avoided based on a first throughput associated with the first CC exceeding a second throughput associated with the second CC.

In a twenty-fourth aspect alternatively or in addition to one or more of the first through twenty-third aspects, the operations include determining one or both of the first throughput or the second throughput based on one or more of scheduling information received from a base station, a channel quality indicator (CQI) reported to the base station, or a block error rate (BLER) measurement.

In a twenty-fifth aspect alternatively or in addition to one or more of the first through twenty-fourth aspects, the operations include: storing, to a throughput database stored at a memory of the UE, a first indication of the first CC; storing, to the throughput database, a second indication of the second CC; sorting the first indication and the second indication within the throughput database according to the first throughput and the second throughput; and accessing the throughput database to identify that the first throughput exceeds the second throughput.

In a twenty-sixth aspect alternatively or in addition to one or more of the first through twenty-fifth aspects, the operations include performing a baseband tune-away operation associated with the first subscription that includes avoiding communication associated with the first subscription using the second CC for at least the time interval.

In a twenty-seventh aspect alternatively or in addition to one or more of the first through twenty-sixth aspects, the second CC is associated with downlink resources, and the operations include transmitting one or more of a particular channel quality indicator (CQI) value or a rank indicator (RI) value to a base station to avoid use of the downlink resources by the base station during the time interval.

In a twenty-eighth aspect alternatively or in addition to one or more of the first through twenty-seventh aspects, the second CC is associated with uplink resources, and the operations include tuning a transmitter of the UE to avoid use of the uplink resources during the time interval.

In a twenty-ninth aspect alternatively or in addition to one or more of the first through twenty-eighth aspects, the one or more operations include at least one control operation performed during an idle mode of the second subscription during the time interval and while the first subscription is associated with a connected mode.

In a thirtieth aspect alternatively or in addition to one or more of the first through twenty-ninth aspects, the one or more operations include one or more of receiving a paging message from a base station, receiving a system information block (SIB) message from the base station, or performing a network measurement.

In a thirty-first aspect alternatively or in addition to one or more of the first through thirtieth aspects, the first subscription is associated with a first radio access technology (RAT) of a concurrent RAT (CRAT) environment supported by the UE, the second subscription is associated with a second RAT of the CRAT environment, and the second RAT is different than the first RAT.

In a thirty-second aspect alternatively or in addition to one or more of the first through thirty-first aspects, the first RAT corresponds to a victim RAT of the CRAT environment, and the second RAT corresponds to an aggressor RAT of the CRAT environment.

In a thirty-third aspect alternatively or in addition to one or more of the first through thirty-second aspects, the operations include, based on expiration of the time interval, reallocating the second CC to the first subscription.

In a thirty-fourth aspect alternatively or in addition to one or more of the first through thirty-third aspects, an apparatus for wireless communication includes means (e.g., the transmitter 356) for transmitting signals. The apparatus further includes means (e.g., the receiver 358) for receiving one or more configuration messages indicating configuration of a first component carrier (CC) and at least a second CC for a first subscription corresponding to a first subscriber identity module (SIM). The means for receiving is configured to perform one or more operations associated with a second subscription corresponding to a second SIM of the UE during a time interval. During the time interval, communication by the first subscription using the second CC is avoided based on a first throughput associated with the first CC exceeding a second throughput associated with the second CC.

In a thirty-fifth aspect alternatively or in addition to one or more of the first through thirty-fourth aspects, one or both of the first throughput or the second throughput are based on one or more of scheduling information received from a base station, a channel quality indicator (CQI) reported to the base station, or a block error rate (BLER) measurement.

In a thirty-sixth aspect alternatively or in addition to one or more of the first through thirty-fifth aspects, the apparatus includes means (e.g., the memory 282) for storing a throughput database and means (e.g., the processor 280) for storing, to the throughput database, a first indication of the first CC and a second indication of the second CC, for storing the first indication and the second indication within the throughput database according to the first throughput and the second throughput, and for accessing the throughput database to identify that the first throughput exceeds the second throughput.

In a thirty-seventh aspect alternatively or in addition to one or more of the first through thirty-sixth aspects, communicating using the second CC is avoided in connection with a baseband tune-away operation from the second CC and associated with the first subscription.

In a thirty-eighth aspect alternatively or in addition to one or more of the first through thirty-seventh aspects, the second CC is associated with downlink resources, and the means for transmitting is configured to transmit one or more of a particular channel quality indicator (CQI) value or a rank indicator (RI) value to a base station to avoid use of the downlink resources by the base station during the time interval.

In a thirty-ninth aspect alternatively or in addition to one or more of the first through thirty-eighth aspects, the second CC is associated with uplink resources, and the transmitter is configured to avoid use of the uplink resources during the time interval.

In a fortieth aspect alternatively or in addition to one or more of the first through thirty-ninth aspects, the means for receiving is further configured to perform at least one control operation of the one or more operations during an idle mode of the second subscription during the time interval and while the first subscription is associated with a connected mode.

In a forty-first aspect alternatively or in addition to one or more of the first through fortieth aspects, the means for receiving is further configured to perform the one or more operations by a paging message from a base station, by receiving a system information block (SIB) message from the base station, or by performing a network measurement.

In a forty-second aspect alternatively or in addition to one or more of the first through forty-first aspects, the first subscription is associated with a first radio access technology (RAT) of a concurrent RAT (CRAT) environment, the second subscription is associated with a second RAT of the CRAT environment, and the second RAT is different than the first RAT.

In a forty-third aspect alternatively or in addition to one or more of the first through forty-second aspects, the first RAT corresponds to a victim RAT of the CRAT environment, and the second RAT corresponds to an aggressor RAT of the CRAT environment.

In a forty-fourth aspect alternatively or in addition to one or more of the first through forty-third aspects, the second CC is reallocated to the first subscription based on expiration of the time interval.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, or modules described herein may include processors, electronics devices, hardware devices, electronics components, logical circuits, memories, software codes, firmware codes, among other examples, or any combination thereof. Software may include instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and operations described herein may be implemented as electronic hardware, computer software, or combinations of both. To illustrate, various illustrative components, blocks, modules, circuits, and operations have been described generally. Whether such functionality is implemented as hardware or software may depend upon the particular application and parameters of the overall system. Skilled artisans may implement the described functionality in varying ways for each particular application, but such implementation decisions should not be interpreted as causing a departure from the scope of the disclosure. Skilled artisans will also readily recognize that the order or combination of components, methods, or interactions that are described herein are examples and that the components, methods, or interactions of the various aspects of the disclosure may be combined or performed in ways other than those illustrated and described herein.

A hardware and data processing apparatus used to implement the various illustrative logics, logical blocks, modules, and circuits described herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform one or more functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In some aspects, one or more functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, or one or more modules of computer program instructions, encoded on a computer storage media for execution by, or to control the operation of, a data processing apparatus.

If implemented in software, the functions may be stored on a computer-readable medium. A processor or method described herein may be implemented in a processor-executable software module which may reside on a computer-readable medium. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a sub combination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
receiving one or more configuration messages indicating configuration of the UE with a first component carrier (CC) and at least a second CC for a first subscription corresponding to a first subscriber identity module (SIM) of the UE; and
performing one or more operations associated with a second subscription corresponding to a second SIM of the UE during a time interval, wherein, during the time interval, communication by the first subscription using the second CC is avoided based on a first throughput associated with the first CC exceeding a second throughput associated with the second CC.

2. The method of claim 1, further comprising determining one or both of the first throughput or the second throughput based on one or more of scheduling information received from a base station, a channel quality indicator (CQI) reported to the base station, or a block error rate (BLER) measurement.

3. The method of claim 1, further comprising:
storing, to a throughput database stored at a memory of the UE, a first indication of the first CC;
storing, to the throughput database, a second indication of the second CC;
sorting the first indication and the second indication within the throughput database according to the first throughput and the second throughput; and
accessing the throughput database to identify that the first throughput exceeds the second throughput.

4. The method of claim 1, further comprising performing a baseband tune-away operation associated with the first subscription that includes avoiding communication associated with the first subscription using the second CC for at least the time interval.

5. The method of claim 1, wherein the second CC is associated with downlink resources, and further comprising transmitting one or more of a particular channel quality indicator (CQI) value or a rank indicator (RI) value to a base station to avoid use of the downlink resources by the base station during the time interval.

6. The method of claim 1, wherein the second CC is associated with uplink resources, and further comprising tuning a transmitter of the UE to avoid use of the uplink resources during the time interval.

7. The method of claim 1, wherein the one or more operations include at least one control operation performed during an idle mode of the second subscription during the time interval and while the first subscription is associated with a connected mode.

8. The method of claim 1, wherein the one or more operations include one or more of receiving a paging message from a base station, receiving a system information block (SIB) message from the base station, or performing a network measurement.

9. The method of claim 8, wherein a duration of the time interval is based on one or more of a duration of a paging occasion associated with the paging message, a duration of a synchronization signal and physical broadcast channel (SS/PBCH) block measurement timing configuration (SMTC) window associated with the SIB message, or a duration associated with performing the network measurement.

10. The method of claim 1, wherein the first subscription is associated with a first radio access technology (RAT) of a concurrent RAT (CRAT) environment supported by the UE, wherein the second subscription is associated with a second RAT of the CRAT environment, wherein the second RAT is different than the first RAT, wherein the first RAT corresponds to a victim RAT of the CRAT environment, and wherein the second RAT corresponds to an aggressor RAT of the CRAT environment.

11. The method of claim 1, further comprising, based on expiration of the time interval, reallocating the second CC to the first subscription.

12. An apparatus for wireless communication, the apparatus comprising:
a transmitter; and
a receiver configured to:
receive one or more configuration messages indicating configuration of a first component carrier (CC) and at least a second CC for a first subscription corresponding to a first subscriber identity module (SIM); and
perform one or more operations associated with a second subscription corresponding to a second SIM during a time interval,
wherein one or both of the transmitter or the receiver are configured to avoid, during the time interval and based on a first throughput associated with the first CC exceeding a second throughput associated with the second CC, communication associated with the first subscription using the second CC.

13. The apparatus of claim 12, wherein one or both of the first throughput or the second throughput are based on one or more of scheduling information received from a base station, a channel quality indicator (CQI) reported to the base station, or a block error rate (BLER) measurement.

14. The apparatus of claim 12, further comprising:
a memory configured to store a throughput database; and
a processor coupled to the memory and configured to:
store, to the throughput database, a first indication of the first CC;
store, to the throughput database, a second indication of the second CC;
sort the first indication and the second indication within the throughput database according to the first throughput and the second throughput; and
access the throughput database to identify that the first throughput exceeds the second throughput.

15. The apparatus of claim 12, wherein communicating using the second CC is avoided in connection with a baseband tune-away operation from the second CC and associated with the first subscription.

16. The apparatus of claim 12, wherein the second CC is associated with downlink resources, and wherein the transmitter is configured to transmit one or more of a particular channel quality indicator (CQI) value or a rank indicator (RI) value to a base station to avoid use of the downlink resources by the base station during the time interval.

17. The apparatus of claim 12, wherein the second CC is associated with uplink resources, and wherein the transmitter is configured to avoid use of the uplink resources during the time interval.

18. The apparatus of claim 12, wherein the receiver is further configured to perform at least one control operation of the one or more operations during an idle mode of the second subscription during the time interval and while the first subscription is associated with a connected mode.

19. The apparatus of claim 12, wherein the receiver is further configured to perform the one or more operations by a paging message from a base station, by receiving a system information block (SIB) message from the base station, or by performing a network measurement.

20. The apparatus of claim 12, wherein the first subscription is associated with a first radio access technology (RAT) of a concurrent RAT (CRAT) environment, wherein the second subscription is associated with a second RAT of the CRAT environment, and wherein the second RAT is different than the first RAT.

21. The apparatus of claim 20, wherein the first RAT corresponds to a victim RAT of the CRAT environment, and wherein the second RAT corresponds to an aggressor RAT of the CRAT environment.

22. The apparatus of claim 12, wherein the second CC is reallocated to the first subscription based on expiration of the time interval.

23. A non-transitory computer-readable medium storing instructions executable by a processor of a user equipment (UE) to initiate, perform, or control operations, the operations comprising:
receiving one or more configuration messages indicating configuration of the UE with a first component carrier (CC) and at least a second CC for a first subscription corresponding to a first subscriber identity module (SIM) of the UE; and
performing one or more operations associated with a second subscription corresponding to a second SIM of the UE during a time interval, wherein, during the time interval, communication by the first subscription using the second CC is avoided based on a first throughput associated with the first CC exceeding a second throughput associated with the second CC.

24. The non-transitory computer-readable medium of claim 23, wherein the operations further comprise determining one or both of the first throughput or the second throughput based on one or more of scheduling information received from a base station, a channel quality indicator (CQI) reported to the base station, or a block error rate (BLER) measurement.

25. An apparatus for wireless communication, the apparatus comprising:
means for transmitting signals; and
means for receiving one or more configuration messages indicating configuration of a first component carrier (CC) and at least a second CC for a first subscription corresponding to a first subscriber identity module (SIM),
wherein the means for receiving is configured to perform one or more operations associated with a second subscription corresponding to a second SIM during a time interval, and wherein, during the time interval, communication by the first subscription using the second CC is avoided based on a first throughput associated with the first CC exceeding a second throughput associated with the second CC.

26. The apparatus of claim 25, wherein one or both of the first throughput or the second throughput are based on one or more of scheduling information received from a base station, a channel quality indicator (CQI) reported to the base station, or a block error rate (BLER) measurement.

27. The apparatus of claim 25, further comprising:
means for storing a throughput database; and
means for storing, to the throughput database, a first indication of the first CC and a second indication of the second CC, for storing the first indication and the second indication within the throughput database according to the first throughput and the second throughput, and for accessing the throughput database to identify that the first throughput exceeds the second throughput.

28. The apparatus of claim 25, wherein communicating using the second CC is avoided in connection with a baseband tune-away operation from the second CC and associated with the first subscription.

29. The apparatus of claim 25, wherein the second CC is associated with downlink resources, and wherein the means for transmitting is configured to transmit one or more of a particular channel quality indicator (CQI) value or a rank indicator (RI) value to a base station to avoid use of the downlink resources by the base station during the time interval.

30. The apparatus of claim 25, wherein the second CC is associated with uplink resources, and wherein the transmitter is configured to avoid use of the uplink resources during the time interval.

31. The apparatus of claim 25, wherein the means for receiving is further configured to perform at least one control operation of the one or more operations during an idle mode of the second subscription during the time interval and while the first subscription is associated with a connected mode.

32. The apparatus of claim 25, wherein the means for receiving is further configured to perform the one or more operations by a paging message from a base station, by receiving a system information block (SIB) message from the base station, or by performing a network measurement.

33. The apparatus of claim 25, wherein the first subscription is associated with a first radio access technology (RAT) of a concurrent RAT (CRAT) environment, wherein the second subscription is associated with a second RAT of the CRAT environment, and wherein the second RAT is different than the first RAT.

34. The apparatus of claim 33, wherein the first RAT corresponds to a victim RAT of the CRAT environment, and wherein the second RAT corresponds to an aggressor RAT of the CRAT environment.

35. The apparatus of claim 25, wherein the second CC is reallocated to the first subscription based on expiration of the time interval.
